(19) United States
(12) Patent Application Publication
(10) Pub. No.: US 2008/0166910 A1
(43) Pub. Date: Jul. 10, 2008

(54) ADAPTOR WITH A PLUG IDENTIFYING MEMBER

(75) Inventor: Tsan-Lan OU-YANG, Taoyuan City (TW)

Correspondence Address: PATENTTM.US, P. O. BOX 82788, PORTLAND, OR, 97282-0788, US

(73) Assignee: ACRON PRECISION INDUSTRIAL CO., LTD., Taoyuan City (TW)

(21) Appl. No.: 11/619,910

(22) Filed: Jan. 4, 2007

(51) Int. Cl. H01R 3/00

(52) U.S. Cl. 439/488

(57) ABSTRACT

An adaptor has a body, two plug identifying members respectively inserted into the body and each having a sliding bar and multiple blocking members. When an incorrect plug with a smaller size is inserted into the body, the blocking members prevent the incorrect plug from being inserted further. When the correct plug is inserted into the body, the plug moves along the sliding bars and pushes the plug identifying members to the top of the body. Therefore, the plug can smoothly insert into the body. When the plug is pulled out of the body, the resilient plug identifying members can return to an original status and thereby exerting the function to the following plug.

### BACKGROUND OF THE INVENTION

1. Field of the Invention

The present invention relates to an adaptor with a plug identifying member, and more particularly to an adaptor that can return to an original status.

2. Description of the Related Art

With the progress of the electrical devices, the telecommunication products are respectively applied widely such as phones and computers. A worldwide transformation method is that a plug is inserted into an adaptor. However, there are various types of plugs such as RJ45 and RJ11 with different standards and functions. When the plug is inserted into an incorrect adaptor, the adaptor is easy to be damaged. To avoid such a condition, a conventional adaptor with a plug identifying member is introduced into the market.

With reference to FIG. 4, the conventional adaptor with a plug identifying member has a body (50) and a plug identifying member (60).

The body (50) has two open ends defined in a front and a rear side of the body (50), a terminal unit (51) mounted in the body (50), and a semi-circular channel (52) defined in the open end of the rear side of the body (50).

The plug identifying member (60) has a round bar formed on an inner edge of the plug identifying member (60) to be engaged with the channel (52), a sliding bar (61) and a blocking member (62) formed on each side of the plug identifying member (60). Two sides of the plug identifying member (60) are respectively inserted into the body (50).

When an incorrect plug with a smaller size is inserted into the body (50), the blocking members (62) can prevent the plug from being inserted to protect the adaptor.

When the appropriate plug is inserted into the body (50), the plug slides along the sliding bars (61) and presses the sliding bars (61) downward.

However, there is no resilient member mounted in the body (50). After the sliding bars (61) are pressed downward, the plug identifying member (60) cannot return to an original status even when the plug is pulled out of the body (50). Hence, the plug identifying member (60) cannot prevent any incorrect plug from inserting unless the plug identifying member (60) is made manually.

Therefore, the invention provides an adaptor with a plug identifying member to mitigate or obviate the aforementioned problems.

### SUMMARY OF THE INVENTION

The main objective of the present invention is to provide an adaptor with a plug identifying member, and more particularly to an adaptor that can return to an original status.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adaptor with a plug identifying member in accordance with the present invention;

FIG. 2 is an exploded perspective view of the adaptor with a plug identifying member in FIG. 1;

FIG. 3 is a side view in partial section of the adaptor with a plug identifying member in FIG. 1; and

FIG. 4 is an exploded perspective view of a conventional adaptor with a plug identifying member in accordance with the prior art.

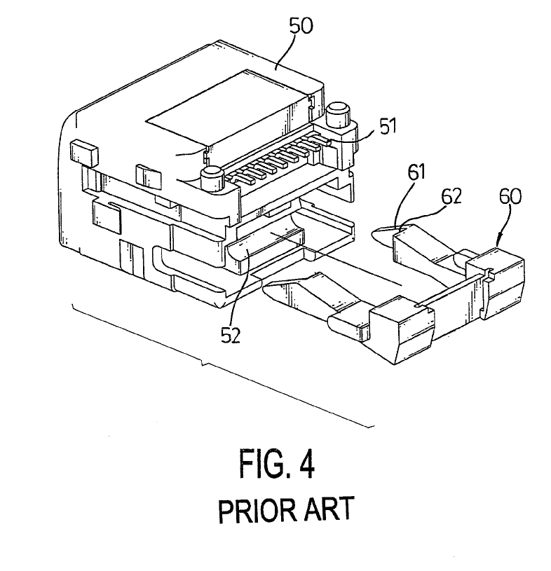

### DETAILED DESCRIPTION OF THE PREFERRED EMBODIMENT

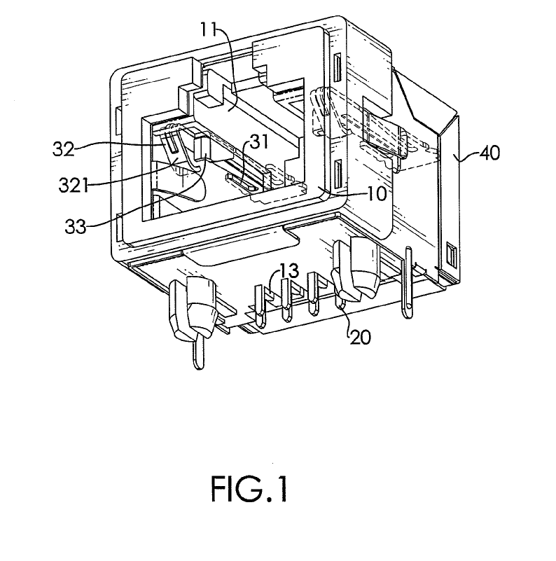

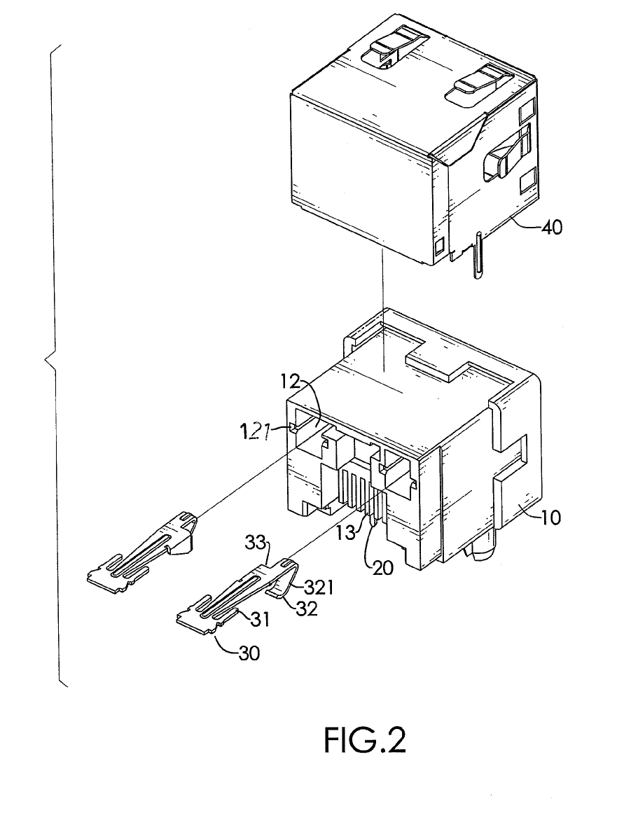

With reference to FIGS. 1 and 2, an adaptor with a plug identifying member in accordance with the present invention has a hollow body (10), a terminal unit (20), two plug identifying members (30) and a shell (40).

The hollow body (10) has an open end (11) defined in a first end of the body (10), two holes (12) and a channel (13) respectively defined in a second end of the body (10), and two slots (121) respectively defined in an inner wall of the body (10) communicating with the holes (12). The channel (13) is located between the holes (12).

The terminal unit (20) is mounted in the channel (13).

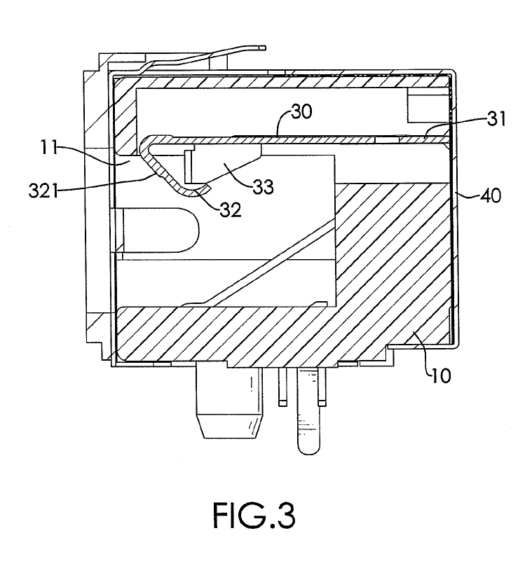

With reference to FIGS. 2 and 3, each plug identifying member (30) is resilient and is inserted into the holes (12). A first end of the plug identifying member (30) is held in the open end (11) and has a siding bar (32) folded to a triangle-like sheet and having a skewed surface (321). Each sliding bar (32) has a blocking member (33). Two lugs (31) are respectively formed in two sides of a second end of the plug identifying member (30) and engage with the slots (121).

The shell (40) is mounted around the body (10).

When incorrect plug with a smaller size is inserted into the body (10), the plug abuts against the blocking members (33) and the blocking member (33) prevents the incorrect plug from being inserted further.

When a correct plug is inserted into the body (10), the plug moves along the skewed surface (321) and pushes the plug identifying member (30) to the top of the body (10). Therefore, the plug can smoothly insert into the body (10).

When the plug is pulled out of the body (10), the resilient plug identifying member (30) can return to an original status automatically and thereby exerting the function to the following plug.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. An adaptor comprising:
a body having
an open end defined in a first end of the body; and
two holes and a channel respectively defined in a second end of the body,
a terminal unit mounted in the channel,
two resilient plug identifying members respectively inserted into the holes of the body, and each plug identifying member having
a first end held in the open end of the body; and
a sliding bar formed on the first end of the plug identifying member and having a blocking member; and
a shell mounted around the body.

2. The adaptor with a plug identifying member as claimed in claim 1, wherein the sliding bar is triangular shaped.

3. The adaptor with a plug identifying member as claimed in claim 1, wherein two slots are respectively defined in an inner wall of the holes of the body, and two lugs are respectively formed in two sides of a second end of each plug identifying member and engaged with the slots in a corresponding hole of the body.

4. The adaptor with a plug identifying member as claimed in claim 3, wherein the channel of the body is defined between the holes of the body.
